(19) United States
(12) Patent Application Publication
(10) Pub. No.: US 2020/0391248 A1
(43) Pub. Date: Dec. 17, 2020

(54) Impact - Screen

(71) Applicant: Justin Jebaraj Osmund, Chennai (IN)

(72) Inventor: Justin Jebaraj Osmund, Chennai (IN)

(21) Appl. No.: 16/761,482

(22) PCT Filed: Dec. 6, 2017
(86) PCT No.: PCT/IN2017/000137

§ 371 Date: May 4, 2020

(30) Foreign Application Priority Data
Nov. 16, 2017 (IN) 201741040963

(51) Int. Cl. B07B 13/10; B07B 13/16

(52) U.S. Cl. CPC B07B 13/10; B07B 13/16

(57) ABSTRACT

An Impact screen is used to screen materials like Urea, NPK and Iron ore . . . etc. Bulk material is received into a hopper which regulates the output. Then it falls into the impact-hopper through the top-conveyor, where it is spread into a thin layer and gets reflected hitting the hit-bar. The reflected material falls oh the bottom-convey—or, in a way fines are at the bottom and gradually the bigger particles on top. Then the layered material is delivered into the 3-way splitter by the bottom conveyor, where it is split into 3 different size ranges and delivered separately through three different ducts.

### FIELD OF THE INVENTION

This invention is about screening of bulk materials like Urea, NPK, sand, iron ore . . . etc. without using screening-meshes.

### DESCRIPTION OF THE PRIOR ART

When it comes to bulk material screening, vibrating screens are being used for many decades now. But due to operational and maintenance difficulties due to meshes, alternate types of screening are evolving. One such type regarding bulk material screening without using meshes, is cyclone type bulk material screening. One such cyclone type screening machine is shown in U.S. Pat. No. 6,186,334 B.

But in this prior art, output is only fines and coarse material and handling large volumes needs a lot of energy and space. In this present invention of Impact-screen, bulk material is segregated into multiple grades, handling large volumes with lesser energy and space.

### SUMMARY OF THE INVENTION

The bulk material to be screened is received into the top-hopper. It has a low-level sensor and a high-level sensor. A manually adjustable regulator-gate at the skirt-board controls the output rate of the material flow at the top-conveyor. A flow sensor sends the rate of flow information to the Process Control Unit (PCU). The top-conveyor is a variable-speed flat-belt conveyor. The flattened bulk material is delivered by the top-hopper into the Impact-hopper, on the pre-expander through the pre-feeder unit. Here the bulk material gets dispersed uniformly sliding through the distributor-plate.

The thin layer of spread out bulk material hits the hit-bar at the back-wall which is vertical and gets reflected in a way, the fines fall close to the back-wall and gradually the bigger particles fall further away from the back-wall. Then the falling material passes through the streamliner which is concave and through the mini-expander which is movable and convex. The mini-expander is moved forward or backward by an actuator-unit which is controlled by the PCU. A linear-sensor monitors the mini-expander movement and sends the feed back to the PCU. The bulk material output after the mini-expander is flat and layered in a way that the fines are at the bottom and bigger particles are on top gradually, as it falls on the bottom-conveyor.

The bottom-conveyor runs at an optimum speed and delivers the layered, flattened bulk material into the 3-way splitter. The two splitter-blades split the layered, flat bulk material into fines, medium and bigger particles and they fall into the first-duct, second-duct and third-duct respectively.

Each of the splitter blades are tilted using separate actuator-units controlled by the PCU. Tilting angles of the splitter-blades are monitored by separate angular-sensors which send feedbacks to the PCU. Each splitter-duct has a post-feeder unit followed by a wear-plate with a post-expander and a particle analyser-unit which has a camera and a light-source.

The separated material falls through the feeder and then dispersed by the post-expander, pass through the particle-size-analyser. If the falling particles are not within the set size range, the particle-size-analyser sends feedback to PCU and the PCU adjusts the splitter-blade accordingly, getting feedbacks from angular-sensors. When the top-hopper input is not constant and the level increases, the high-level alarm is activated, the PCU increases the speed of the top-conveyor and slows the speed of the bottom-conveyor.

When the top-hopper input decreases, the low-level alarm is activated, the PCU decreases the speed of the top-conveyor and increases the speed of the bottom-conveyor. When the rate of bulk material flow increases, PCU moves the mini-expander forward and when the rate of bulk material flow decreases PCU moves the mini-expander backward so that the output from the Impact-hopper is flat.

The foregoing abstract is not to be taken as limiting the invention described herein, and in order to understand the full nature and extent of the technical disclosure herein, reference should be made to the accompanying drawings and detailed description.

### BRIEF DESCRIPTION OF THE DRAWINGS

In order that the invention may be more fully understood, some embodiments will now be described with reference to the figures in which:

FIG. 1 is a perspective right-side view of an impact-screen;

FIG. 2 is a perspective angular view of the top-hopper and the top-conveyor;

FIG. 2a is a perspective view of the top-hopper regulator;

FIGS. 3 & 4 are perspective views of impact-hopper's front and back portions;

FIG. 5 is an angular right-side perspective view of impact-hopper;

FIG. 6 is the vertical cut-view of impact-hopper with the back-wall removed;

FIG. 7 is the vertical cross-section view of impact-hopper with the right-side walls removed;

FIG. 8 is the horizontal cross-section view of the impact-hopper showing the streamliner and the mini-expander;

FIG. 9 is impact-hopper skirt-board left side view showing left-side movable-studs of mini-expander unit;

FIG. 10 is a perspective view of distributor wear-plate with pre-expander;

FIG. 11 is a perspective bottom view of impact-hoppershowing mini-expander unit inside Impact-hopper;

FIG. 12 is a perspective view of the distributor base-plate;

FIG. 13 is a perspective view of the mini-expander movable stud;

FIG. 14 is a perspective view of inclined, removable, lower left-side or right-side wall;

FIG. 15 is a perspective view of side-wall wear-plate;

FIG. 16 is a perspective view of hit-bar;

FIG. 17 is a perspective view of the removable bracket for mini-expander movable studs;

FIG. 18 is a perspective view of mini-expander unit;

FIG. 19 is a perspective back-side view of streamliner with the bracket;

FIGS. 20 & 21 are perspective views of pre-feeder fixing brackets and pre-feeder respectively;

FIG. 22 is a perspective view of a U-clamp with bolt & nuts which hold the hit-bar;

FIG. 23 is a perspective view of the dust-pan;

FIGS. 24 & 25 are perspective right-side and left-side views respectively of a 3-way splitter;

FIGS. 26 & 27 are transparent view of a 3-way splitter from Its right side;

FIG. 28 is a perspective plan view of a 3-way splitter;

FIG. 29 is a perspective plan view of top-hopper;

FIG. 30 is a perspective angular view of an Impact-screen with outer casing;

FIG. 31 is perspective angular views of first splitter-blade and second splitter-blade;

FIG. 32 is a perspective view of the dust-header with branch-pipes;

FIG. 33 is a schematic block-diagram showing the inputs outputs of PCU;

FIG. 34 is a schematic block-diagram of splitter-unit dust-handling system;

FIGS. 35 & 36 are perspective views of first-duct wear-plate and second-duct wear-plate respectively;

FIGS. 37 & 38 are perspective views of post-feeder-1 unit fixing brackets and post-feeder-1unit respectively;

FIGS. 39 & 40 are perspective views of post-feeder-2 unit and post-feeder-2 unit fixing brackets respectively;

FIG. 41 is a perspective view of a 4-Way splitter;

FIG. 42 is a perspective view of a 2-way splitter;

FIG. 43 is a perspective view of a simple 2-way splitter.

### DETAILED DESCRIPTION OF THE PREFERRED EMBODIMENTS

In describing different embodiments of the present invention common reference numerals are used to describe like features.

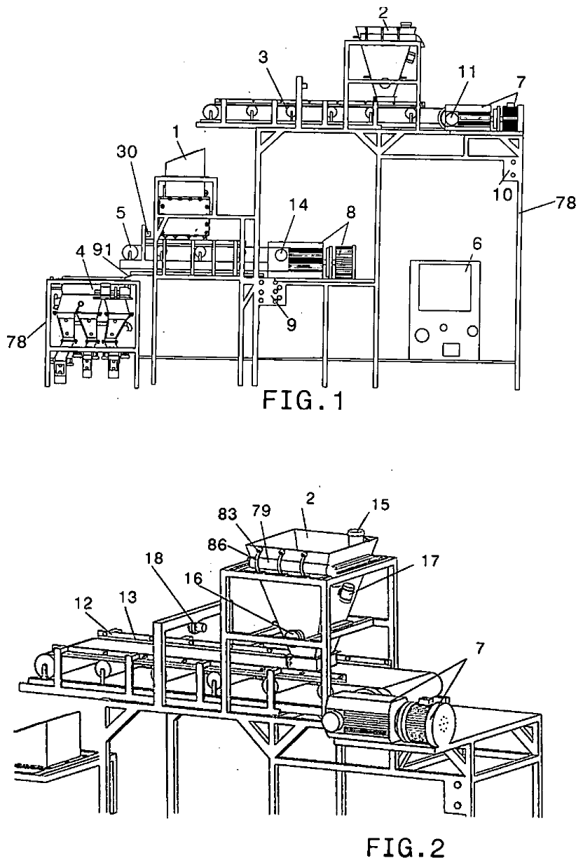

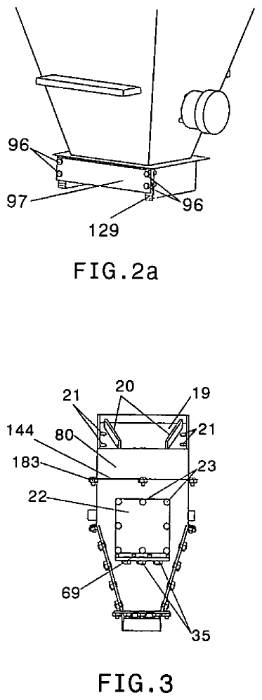

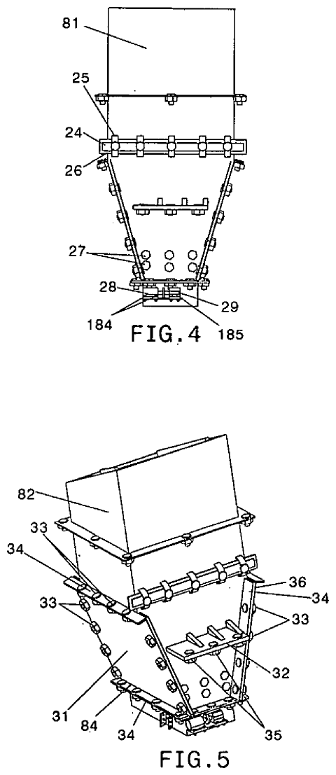

Referring to FIG. 1 there is shown 2 the top hopper which receives the bulk material with moisture level of bulk material not exceeding 0.5 to 1.5% by weight depending on the type of bulk material used. The top hopper 2 has a high level sensor 15 and a low level sensor 16 which send signal to the computer 6 in FIG. 1 known as Process-Control-Unit, PCU in short. The top hopper 2 has a vibrator 17 as shown in FIG. 2 attached to it, which works at equal intervals to avoid deposits and for free flow of bulk material received.

Referring to FIG. 2a, there is shown the regulator-gate 97, fixed at the skirt-board of Top hopper 2. The regulator-gate 97 can be moved up or down and fixed in position by bolts and nuts 96 which move in rectangular slots (not shown). The top half portion of the skirt-board behind the regulator-gate 97 is partially closed by a welded plate to avoid spilling over of bulk material when the regulator-gate 97 is lowered. There are position markings 129 as shown in FIG. 2a, to know the position and alignment of regulator-gate 97. The received bulk material gets flattened as it flows through the regulator-gate 97.

Underneath the top hopper 2 is the top Conveyor 3 as shown in FIG. 1. It is a flat-belt conveyor. It is powered by a variable speed drive-unit 7 with the speed-sensor 11 as shown in FIGS. 1 and 2. A local switch-panel 10 is provided to start or stop the top-conveyor locally. It has got guide-plates 12 on both sides of the flat conveyor belt. A rubber-strip 13 is bolted to the guide-plate 12 to avoid bulk material from straying away. After the regulator-gate 78 a bulk-material flow-sensor unit 18 is fixed as shown in FIG. 2. The bulk material flow-sensor unit 18 senses the rate of flow of passing bulk material and sends information to the PCU 6. After top conveyor 3 the impact-hopper 1 is located as shown in FIG. 1. impact-hopper 1 is an important part of this invention, since most part of the separation happens here. The flange 144 fixed by welding, at the upper portion of the impact-hopper 1, is connected to the main supporting structure 78 using bolts and nuts 183. At the middle level the bracket 69 welded to the front-wall 80, and the bracket 32 welded to the back-wall 81, are attached to the main supporting structure 78 by bolts and nuts 35.

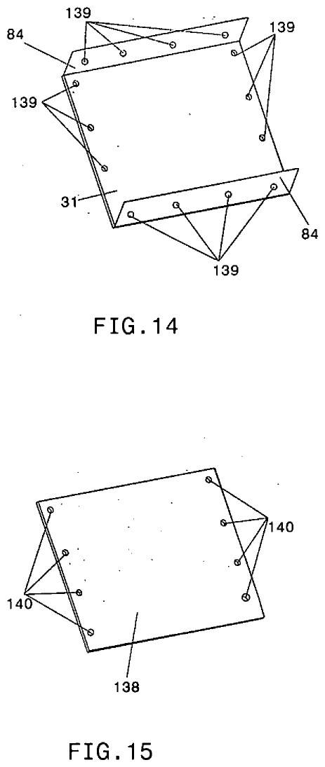

The impact-hopper 1 has two parallel vertical walls known as front-wall 80 and back-wall 81 as shown in FIG. 3 and FIG. 4. On the left side, it has vertical upper left side wall 85 and inclined, removable lower left side wall 36. On the right side, it has vertical upper right side wall 82 and inclined, removable lower right side wall 31 as shown in FIGS. 4 & 5. As shown in FIG. 14, removable lower right side wall 31 has flanges 84, with fixing holes 139. The removable lower left side wall 36 is similar to the removable lower right side wall 31. The removable lower left side wall 36 and the removable right side wall 31 are fixed to respective flanges by plurality of bolts and nuts 33. The front-wall 80 has an inspection door 22 fixed by plurality of bolts and nuts 23 as shown in FIG. 3.

The brackets in the front-wall 80 and back-wall 81 are fixed to the structure 78 by bolts and nuts 35. The upper flange 144 is fixed to the structure 78 by bolts and nuts 183.

The impact-hopper 1 has replaceable wear-plate known as side wall wear-plate 138 with fixing plurality of preset holes 140 as shown in FIG. 15 is fixed in between inclined, removable, lower left side wall 36 and flanges 34; and another said side wall wear-plate 138 is fixed between inclined, removable, lower right side wall 31 and flanges 34 wherein rubber or other suitable material gaskets are introduced in-between each of the flanges so that only the wear-plate 138 surface comes in contact with the falling bulk material.

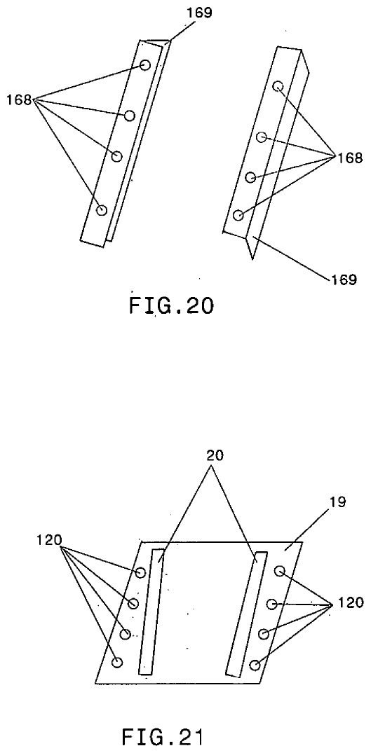

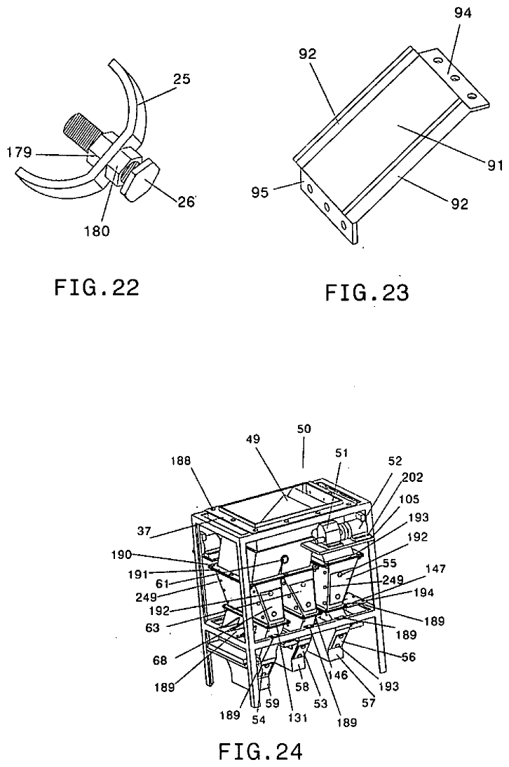

The flattened bulk material is received by the pre-feeder unit inside the impact hopper 1, which has the feeder-plate 19 with guide-plates 20 as shown in FIG. 3. and FIG. 21. The feeder-plate fixing brackets 169 are welded to the vertical upper left side wall 85 and vertical upper right side wall 82 at an optimum inclined angle, according to the characteristics of the bulk material handled. The feeder-plate 19 is fixed to the fixing brackets 169 as shown in FIG. 20, through plurality of holes 168 in the fixing brackets 169 and plurality of holes 120 in the feeder-plate 19 using plurality of bolts and nuts 21.

The bulk material from the pre-feeder unit is received by the distributor unit. The distributor unit comprises a thick base-plate known as distributor base-plate 141 welded to the inner side of front wall 80 and also welded to the inner side of said vertical, upper left side wall 85 and vertical, upper right side wall 82, in an inclined position, for the free flow of bulk material, just below the pre-feeder, proceeding from the front wall 80 towards the back wall 81 and ends just before touching the back wall 81 giving a gap known as the hit gap 87, which depends on the bulk material size range and speed at which the material slides down the distributor wear-plate 38 and is fixed.

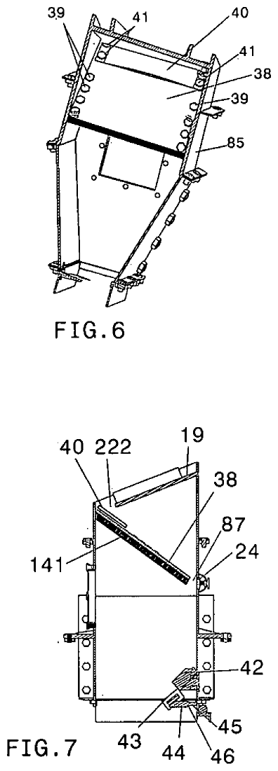

Referring to FIGS. 6,10 & 12, the distributor unit comprises a wear-plate known as the distributor wear-plate 38 positioned over the base-plate 141 and bolted to threaded holes 143 in the distributor base-plate 141, through the preset holes 187 in the distributor wear-plate by plurality of bolts and nuts 39. The distributor unit comprises a convex strip known as pre-expander 40 at the bulk material receiving end, set on top of the distributor wear-plate 38, bolted to plurality of threaded holes 142 in the distributor base-plate 141, through aligned holes 41 in the distributor wear-plate 38 and in both ends of the pre-expander 40. The distributor unit comprises two deflectors 88 fixed at the two corners of the discharge end of the distributor wear-plate 38 and are bolted to plurality of threaded holes 156 in the distributor base-plate 141 through aligned holes 115 in the distributor wear-plate 38 and the two deflectors 88.

The feed plate 19 ends just before said pre-expander 40 and focuses on the centre of the pre-expander 40 giving a gap known as feed-gap 222 which depends on the bulk material size range and speed at which the material slides down the feed-plate 19 and is fixed. The inclination angle of the feed plate 19 and the inclination angle of the distributor base-plate 141 are fixed. Referring to FIGS. 6 & 7 the bulk material falling on the pre-expander 40 is spread as a thin layer on the distributor wear-plate 38, slides on the distributor wear-plate 38 and hits the hit-bar 24 passing through the hit-gap 87. Even at maximum load the bulk material gets spread in between the deflectors 88 before hitting the hit-bar 24. The straying bulk material particles are diverted by the deflectors 88 to hit the hit-bar 24.

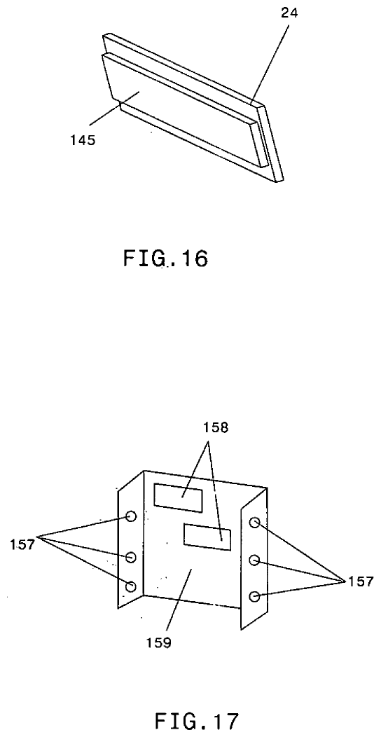

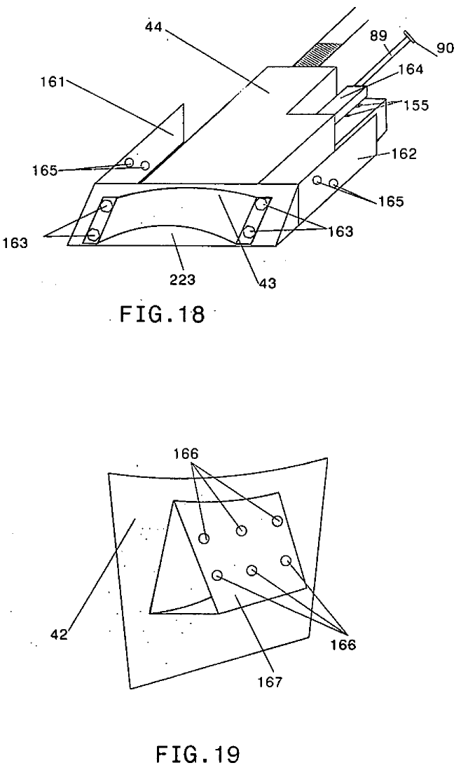

The hit-bar 24 is located at the back-wall 81 just above the inclined, removable, lower left side wall 36 and the inclined, removable, lower right side wall 31. As shown in FIG. 16, the hit-bar 24 has a step 145 inward as to fit perfectly with the inner surface of the back wall 81. As shown in FIGS. 4,5 and 22, the hit-bar 24 is fixed in position by plurality of U-clamps 25, the legs of which are welded to said back wall 81 and plurality of bolts 26, by plurality of fixed nuts 179 which are welded to the U-clamps and plurality of lock nuts 180. The hit-bar 24 is quickly replaceable and is made of steel or other alloys or metal or elastomeric material.

The thin layer of bulk material hits the hit-bar 24 and gets reflected according to Newton's 3rd law of motion and hence the fine particles fall close to the back-wall 81 and gradually bigger particles fall away from the back-wall 81. Part of the reflected particles fall forward and part of the reflected particles falls on the inclined, removable, lower left side wall 36 and the rest on the inclined, removable, lower right side wall 31. Collectively all the reflected material falls on streamliner 42.

The streamliner 42 is a concave trapezium plate with a barrier blade 47 at its centre as shown in FIGS. 7 & 8, fixed below the hit-gap 87, in an inclined position, touching the inclined, removable, lower left side wall 36 and the inclined, removable, lower right side wall 31, bolted to the back-wall 81 with a bracket 167 welded to the back part of the streamliner 42 by plurality of nuts 166 welded to the bracket 167 as shown in FIG. 19, by plurality of bolts 27 through plurality of holes in the back wall 81. The barrier blade 47 edges are sharp.

The streamliner 42 receives the falling material in a manner the finer particles are at the bottom and gradually the bigger particles are on top. The streamliner output material is convex at the centre and flat on the sides since the streamliner 42 is concave. After passing through the streamliner 42, the layered bulk material falls on the mini-expander 43.

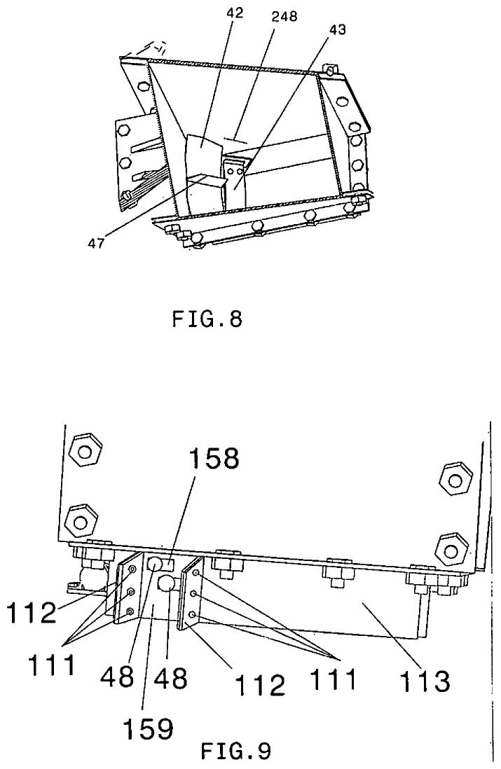

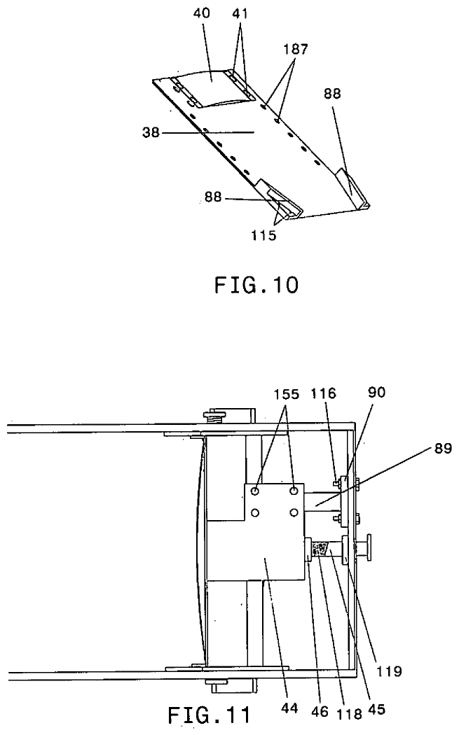

Referring to FIGS. 8,11 & 18, the mini-expander unit comprises a mini-expander 43 bolted to mini-expander base 223 by plurality of bolts and nuts 163, the mini-expander-base 223 welded to bracket 44 means a hollow box type bracket; left arm 161 means a flat strip attached to left side of the mini-expander base 223; the right arm 162 means a flat strip attached to right side of the mini-expander base 223; an adapted linear motion potentiometer sensor 164 bolted to the bracket 44 using bolts 155 and linear-motion potentiometer-sensor—piston 89 with the piston-head 90 bolted to back side of the skirt-board 113 by plurality of bolts and nuts 116; an adapted actuator unit known as mini-expander actuator-unit, means a motor 28 coupled to a self-locking (worm-gear) gear-box 29 fixed on base 185 using bolts and nuts 184, coupled to a shaft 45 with threads 118, means the shaft 45 using journal bearing 119 fixed to back side of the skirt-board 113, the shaft with threads 118 fitting in to a nut 46, the nut 46 welded inside a hole in the bracket 44; two threaded holes in said left arm 161 and two threaded holes in the right arm 162 are for fixing studs 48. The skirt-board 113 is covered on left, right and back sides except on front side through which, layered bulk material flows forward. The skirt-board 113 is fixed to the Impact-hopper by its flange connected to the Impact-hopper bottom flange 34, stays just above the bottom conveyor 5 leaving a gap. As shown in FIG. 9, the skirt-board 113 on the left side and on the right side a removable bracket 159 on each side is fixed to flanges 112 by bolts and nuts 111 through the holes 157 in the removable bracket 159.

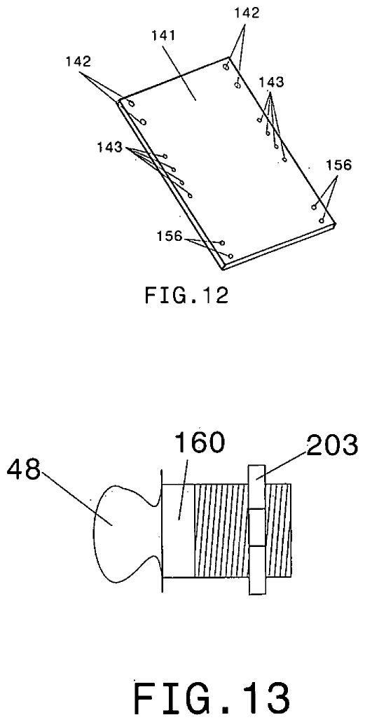

The top portions of said flanges 112 are connected to flange 34 by welding. As shown in FIG. 17, the two slots 158 are provided in each of the removable bracket 159, in which two movable studs 48 move, which are connected through holes 157, into threaded holes 165 in the left arm 161 and the right arm 162 in the mini-expander unit, with lock nuts 203 at their ends. The stud 48 as shown in FIG. 13 has a bush area 160, which is the sliding portion. The equaliser-gap 248 means, the distance between the streamliner 42 discharge edge and the mini-expander 43 discharge edge. The PCU 6 using the mini-expander actuator unit, increases the equaliser-gap 248 when the bulk material flow after the regulator 78 increases and decreases the equaliser-gap 248 when the bulk material flow after the regulator 78 decreases. Thus the convex portion of layered bulk material coming out of the Impact-hopper 1 is neutralised. The overall output material coming out of impact-hopper 1 is a layered, flat bulk material as it falls on the bottom-conveyor 5. The bottom conveyor 5 has a variable speed drive-unit 8 with speed-sensor 14 as shown in FIG. 1. Also a local switch panel 9 is provided to start or stop manually the bottom conveyor 5 and to control splitter blades position manually.

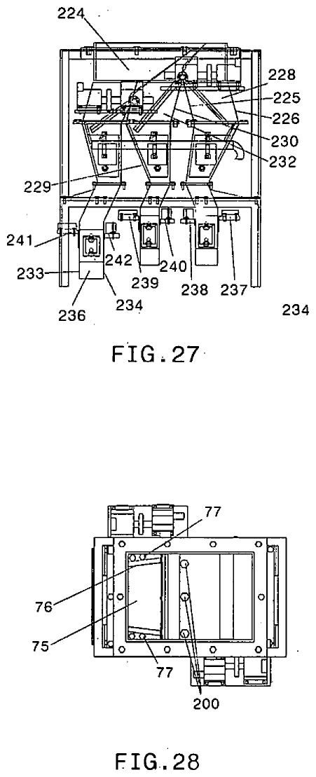

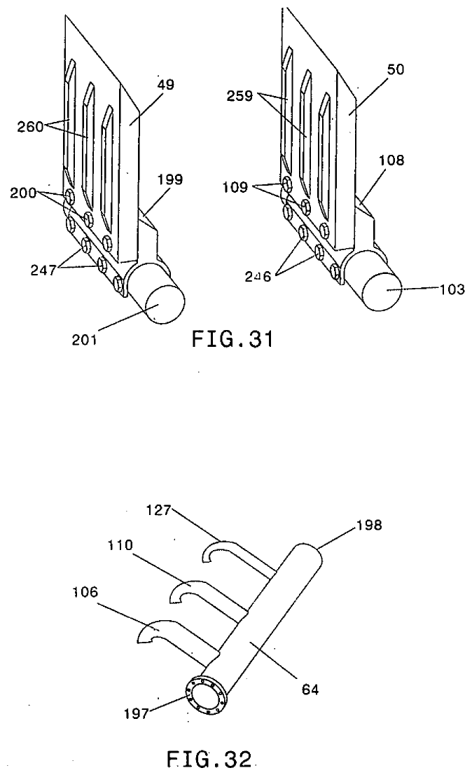

Referring to FIG. 24 upto FIG. 28 and FIG. 31, the layered, flat bulk material is carried by the bottom conveyor 5 and delivered in to the 3-way splitter. The bottom conveyor runs at an optimum speed, that the layered, flat bulk material is thrown in to the 3-way splitter 4, where according to Newton's second law of motion, the fine particles fall closer, where bigger particles fall away which are captured and separated by the first splitter-blade 50 and second splitter-blade 49.

The three-way splitter has the top-box 224, which is fixed to the structure 78 by the flange 37 fixed by plurality of bolts and nuts 188, comprises the first-splitter-blade 50 having stiffeners 259, fixed to first splitter-blade base 108 using plurality of bolts and nuts 109; the first splitter-blade base 108 being connected to first splitter blade shaft 103 using bolts and nuts 246; the first splitter shaft 103 being journaled to the top-box 224 on both sides and the actuator side being coupled to self locking gear-box 51; the opposite side being fixed with an angular sensor 62; a second splitter-blade 49 having stiffeners 260, fixed to second splitter-blade base 199 using plurality of bolts and nuts 200; the second splitter-blade base 199 being connected to second splitter-blade shaft 201 using plurality of bolts and nuts 247; the second splitter-blade shaft 201 being journaled to the top-box 224 on both sides and the actuator side being coupled to self locking gear-box 65; the opposite side being fixed with an angular sensor 61; a first-splitter blade actuator unit comprises a motor 52 coupled to a self locking gear-box 51; a second-splitter blade actuator comprising a motor 67 coupled to a self locking gear-box 65; a first splitter-blade actuator-unit base 105 and a second splitter-blade actuator-unit base 196 fixed by welding, diagonally opposite to each other on the outer side of the top-box 224. The motor 52 is coupled to the self locking gear-box 51, fixed to the first splitter actuator-unit base 105 by plurality of bolts and nuts 202. The motor 67 is coupled to the self locking gear-box 65 and fixed to the second-splitter-actuator-unit base 196 by plurality of bolts and nuts 195. The flange 37 at the top edge of the top-box 224 is connected to the angles of the support structure by plurality of bolts and nuts 188.

The bottom portion of the top-box 224 below the first splitter blade shaft 103 branches into first duct 57 and second duct 58. The bottom portion of, the top-box 224 below the second splitter blade shaft 201 branches into the second duct 58 and third-duct 59.

Each splitter duct has three segments namely top segment, middle segment and bottom segments. The top segment of the first duct 57 is the portion between the first splitter blade shaft 103, first duct back wall 226 and first duct middle pair of flanges 193. The middle segment of the first duct 57 is the portion between the first duct middle pair of flanges 193 and first duct bottom pair of flanges 147. The bottom segment of the first duct 57 is the portion below the first duct bottom pair of flanges 147 upto the portion just below the clean-out door 56. The middle pair of flanges are connected by bolts and nuts 190 as shown in FIG. 24.

The top segment of the second-duct 58 and top segment of the third duct 59 have a common middle pair of flanges 191. The top segment of second duct 58 is the portion between the two splitter-blades and the middle pair of flanges 191. The middle segment of the second duct 58 is the portion between the middle pair of flanges 191 and bottom pair of flanges 146. The bottom segment of the second duct 58 is the portion between the bottom pair of flanges 146 upto the portion below the clean out door 53.

The top segment of third-duct 59 is the portion between the second splitter-blade 49, and the middle pair of flanges 191. The middle-segment of the third-duct 59 is the portion between the middle pair of flanges 191 and bottom pair of flanges 131. The bottom segment of the third-duct 59 is the portion between the bottom pair of flanges 131 upto the portion below the clean out door 54. The brackets 189 are welded at the outer side of the bottom segments of first duct 57, second duct 58 and third duct 59 below the bottom pairs of flanges and are fixed to holes in the angles of the frame 78 by bolts and nuts 194 using holes near the edges of the brackets 189. The same level brackets 189 are welded at first duct front wall 225 and second duct back wall 230, which are connected by bolts and nuts. The brackets 189 are welded at the second duct front wall 229 and third duct back wall 234, which are connected by bolts and nuts.

Just below the first splitter blade shaft 103, and inside the first duct 57 post-feeder-1, a feeder-plate 73 is connected to brackets 213 welded at an inclined position to the inner side of left side wall 227 and right side wall 228 by bolts and nuts through the holes 214 in the post-feeder-1 feeder plate 73 and holes in the brackets 212. The post-feeder-1 feeder-plate 73 inclines from the front-wall 225 towards the back-wall 226 leaving a gap known as the first-duct post-feeder-gap 261 and has guide strips 215.

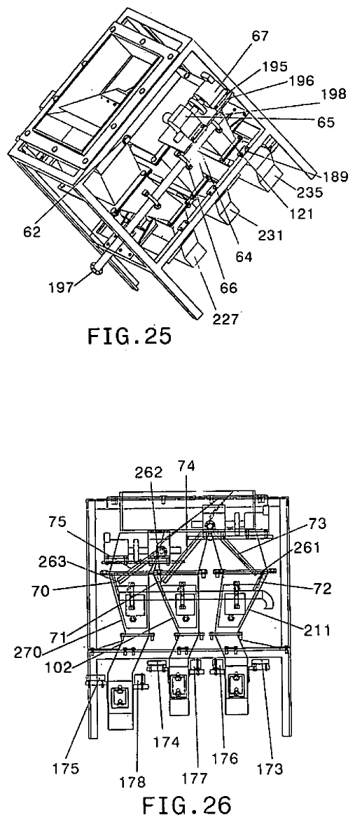

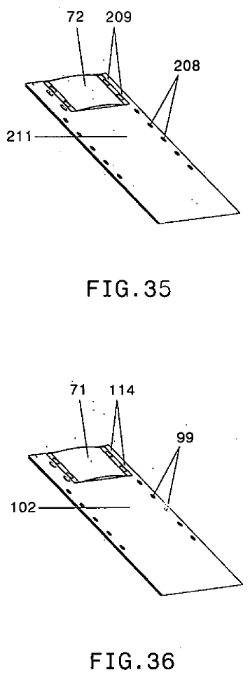

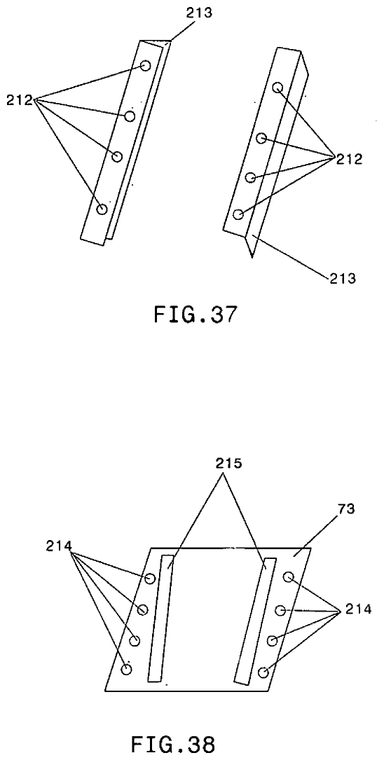

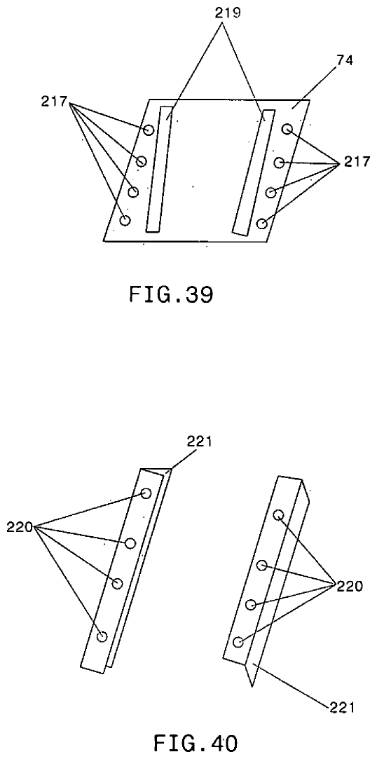

Referring to FIG. 35 upto FIG. 40, below post-feeder-1, wear-plate-1 (211) which is a rectangular plate covering area between middle pair of flanges 193 and bottom pair of flanges 147 is fixed to holes in the back-wall 226 by bolts and nuts 249. The post-expander-1 (72) is fixed at the upper portion of the wear-plate-1 (211) through set holes 209 and through set holes 208 in the wear-plate-1 (211) and set matching holes in the back-wall 226 using bolts and nuts as shown in FIGS. 24, 26 & 35.

The middle segments are wider than the top-box 224 in order to handle the expanded bulk material. The bottom segments below the camera and light source, the ducts narrow down to fit a conveyor skirt box or a conveyor inlet duct or an elevator inlet duct.

The bottom segment of the first duct 57 comprises a light-source base 237 attached to the outer side of the back wall 226 by welding; a rectangular slit provided at the back wall 226 in front of the light source 173 for the light to pass through; a camera base 238 attached to the outer side of the front wall 225 by welding; a hole is provided at the front wall 225 in front of the camera 176 for the camera 176 to receive light from the light source 173. The light source 173 is fixed to the base 237 using bolts and nuts through holes in the base 237 and holes in said light source 173. The camera 176 is fixed to said base 238 using bolts and nuts through holes in the base 238 and holes in the camera 176. The bottom-segment, the camera, its base and the corresponding hole on the wall can be on either wall (back wall or front wall). The light source, its base and corresponding slit can be on either wall (back wall or front wall), based on the condition that both (camera and light source) must be on opposite walls to each other. This condition applies to each of said ducts.

The middle-segment of the first duct 57, comprises of a clean-out door 55 fixed using plurality of bolts 192 through holes in the clean out door 55 fitting in to nuts welded on the inner side of said right side wall 228 through preset holes in the right side wall 228. The bottom segment of the first duct 57 comprises of a clean out door 56 fixed using plurality of bolts 193 through holes in the clean-out-door 56 fitting in to nuts welded on the inner side of the right side wall 228 through preset holes in the right side wall 228.

Just below the first splitter-blade shaft 103, inside the second duct 58 the post-feeder-2 feeder-plate 74 is connected to brackets 221 welded at an inclined position to the inner side of left side wall 231 and right side wall 232 by means of bolts and nuts through preset holes 217 in the post feeder-2 feeder plate 74 and preset holes 220 in the brackets 221. The post-feeder-2 feeder-plate 74 inclines from the back-wall 230 towards the front-wall 229 leaving a gap known as the second-duct post-feeder-gap 262 and has guide strips 219. Below post-feeder-2, wear-plate-2 (102) which is a rectangular plate covering area between middle pair of flanges 191 and bottom pair of flanges 146 is fixed to holes in the front-wall 229 by bolts and nuts (249). The post-expander-2 (71) is fixed at the upper portion of the wear-plate-2 (102) through set holes 114 and set holes 99 in the wear-plate-2 (102) and set matching holes in the front-wall 229 using bolts and nuts as shown in FIGS. 24, 26 & 36. The middle segment of the second duct 58, comprises of a clean-out door 63 fixed using plurality of bolts 192 through holes in the clean out door 63 fitting in to nuts welded on the inner side of the right side wall 232 through preset holes in the right side wall 232. The bottom segment of the second duct 58 comprises a light-source base 239 attached to the outer side of the back wall 230 by welding; a rectangular slit is provided at the back wall 230 in front of the light source 174 for the light to pass through; a camera base 240 attached to the outer side of the front wall 229 by welding; a hole is provided at the front wall 229 in front of the camera 177 for the camera 177 to receive light from the light-source 174. The bottom segment of the second duct 58 comprises of a clean out door 53 fixed using plurality of bolts 193 through preset holes in the clean out door 53 fitting in to nuts welded on the inner side of the right side wall 232 through preset holes in the right side wall 232. The light source 174 is fixed to the base 239 using bolts and nuts through preset holes in the base 239 and holes in the light source 174. The camera 177 is fixed to the base 240 using bolts and nuts through preset holes in the base 240 and holes in the camera 177.

Just below the second splitter-blade shaft 201, inside the third duct 59 the post-feeder-3 feeder-plate 75 is connected to brackets (not shown) welded at an inclined position to the inner side of left side wall 235 and right side wall 236 by means of bolts and nuts through preset holes in the post feeder-3 feeder plate 75 and preset holes in the brackets. The post-feeder-3 feeder-plate 75 inclines from the back-wall 234 towards the front-wall 233 leaving a gap known as the third-duct post-feeder-gap 263. The post-feeder-3 feeder-plate 75 as shown FIG. 28 is fixed by bolts and nuts 77 and has guide strips 76.

Below post-feeder-3, wear-plate-3 (270) which is a rectangular plate covering area between middle pair of flanges 191 and bottom pair of flanges 131 is fixed to holes in the front-wall 233 by bolts and nuts 249. The post-expander-3 70 is fixed at the upper portion of the wear-plate-3 (270) through set holes in the wear-plate-3 (270) and set matching holes in the front-wall 233 using bolts and nuts as shown in FIGS. 24 & 26.

The middle-segment of the third duct 59, comprises of a clean out door 68 fixed using plurality of bolts 192 through holes in the clean out door 68 fitting in to nuts welded on the inner side of the right side wall 236 through preset holes in the right side wall 236.

The bottom-segment of the third-duct 59 comprises a light-source base 241 attached to the outer side of the back wall 234 by welding; a rectangular slit is provided at the back wall 234 in front of the light-source 175 for the light to pass through; a camera base 242 attached to the outer side of the front wall 233 by welding; a hole is provided at the front wall 233 in front of the camera 178 for the camera 178 to receive light from the light source 175.

The bottom-segment of the third-duct 59 comprises of a clean out door 54 fixed using plurality of bolts 193 through preset holes in the clean out door 54 fitting into nuts welded on the inner side of the right side wall 235 through preset holes in the right side wall 236. The light source 175 is fixed to the base 241 using bolts and nuts through preset holes in the base 241 and holes in the light source 175. The camera 178 is fixed to the base 242 using bolts and nuts through preset holes in the base 242 and holes in the camera 178.

As shown in FIGS. 1 and 23, a dust pan 91, which has guide rails 92, fixed to the bottom conveyor 5 discharge frame by bolting its upper flange 94 and fixed to the inner side of back wall 226 of the first duct 57 by its bottom flange 95, where fine dust gets collected and slides into the first duct 57.

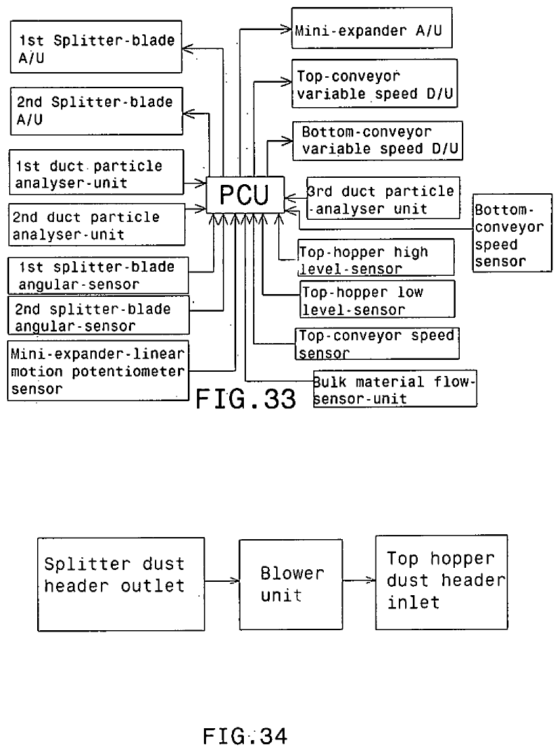

Referring to FIG. 33, there is shown the various inputs and outputs of PCU 6. The Impact-screen as shown in FIG. 30, a casing 130 is provided, to protect falling bulk material from the top conveyor 3 discharge and bottom-conveyor 5 discharge, from wind. It has doors 125 on left, right and front sides. It has a dust pick up point 126 on top.

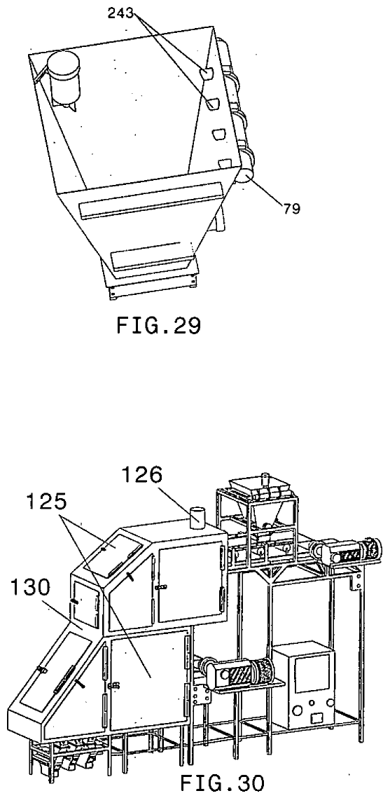

The embodiment shown in FIGS. 2, 25, 29, 32 & 34, the dust removal pipe 64 which branches into three bent pipes namely pipe—a 106, pipe—b 110 and pipe—c 127 and are inserted in to middle segments of right side walls of the first duct 57, the second duct 58 and the third duct 59 respectively. The pipe—a 106 is biggest, the pipe—b 110 smaller and the pipe—c 127 the smallest and pipe-ending 198 at the third duct 59 is a blind end. The flange 197 is connected to the suction pipe of a dust removal blower and the discharge pipe 79 of the blower branches out into plurality of small bent pipes 243 which are fixed in to the upper portion of top hopper 2 by U-clamps 86 using bolts and nuts 83. The dust-removal-pipe 64 is fixed using clamps 66 and bolts and nuts 121.

The dust-removal pipe 64 is fixed to the right side walls or the left side walls of the middle segments of the first, second and third ducts on condition, the clean-out doors will be on the opposite side walls.

In the embodiment shown in FIG. 1, a contour-sensor 30 is fixed immediately after the mini-expander 43, on the bottom-conveyor 5, which senses whether the layered, flattened bulk material is flat or convex or concave and sends information to the PCU 6, and PCU 6 adjusts said mini-expander 43 so that the layered, flattened bulk material is flat.

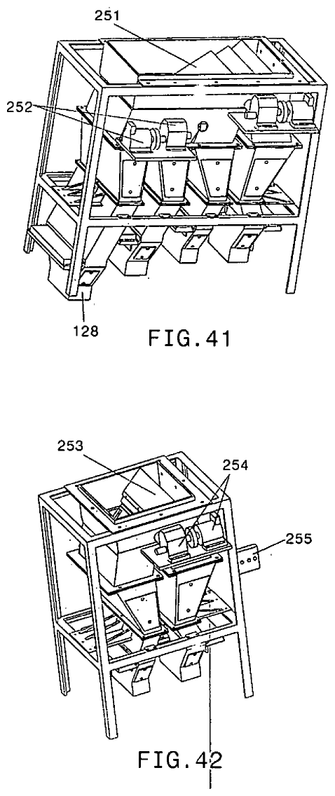

In the embodiment shown in FIG. 41, a 4-way splitter comprises four splitter-ducts, three splitter blades with three splitter-blade angular sensors and three splitter-blade actuator-units controlled by said PCU 6 and three particle-size-analyser units controlled by said PCU 6 is used in place of a said 3-way splitter 4. It has, the fourth splitter-duct 128, third splitter-blade actuator unit 252 and the third splitter-blade 251.

In the embodiment shown in FIG. 42, a 2-way splitter comprises two splitter-ducts, a single splitter-blade 253 with a single splitter-blade angular sensor and with a single splitter-blade actuator unit 254 controlled by said PCU 6 and a single particle-analyser-unit controlled by said PCU 6 is used in place of said 3-way splitter 4. It has a local switch-panel 255.

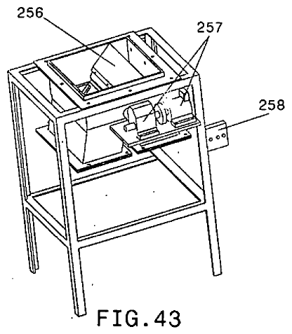

In the embodiment shown in FIG. 43, a 2-way splitter duct comprises two splitter ducts, a single splitter-blade 256 with a single splitter-blade angular sensor and a single splitter-blade-actuator-unit 257, splitting on percentage of fines in incoming load basis, controlled by said PCU 6. It has a local switch-panel 258.

The Impact-screening machine is mounted on wheels or tracks in mobile screening units other than using in fixed positions.

Although the present invention has been described in connection with preferred embodiment's thereof, it will be appreciated by those skilled in the art that additions, deletions, modifications; and substitutions not specifically described may be made without department from the spirit and scope of the invention as defined in the appended claims

1-134. (canceled)

135. An Impact hopper comprises:
two vertical, parallel walls namely front wall (80) and back wall (81)
a vertical, upper left side wall (85)
an inclined, removable, lower left side wall (36)
a vertical, upper right side wall (82)
an inclined, removable, lower right side wall (31)
a hit bar (24)
a pre-feeder unit, which has the feed plate (19) and two guide rails (20)
a distributor unit, which has the base-plate (141), pre-expander (40) and two deflectors (88)
a streamliner (42)
a mini-expander unit, which has a mini expander (43) and two movable studs (48).

136. The Impact hopper as claimed in claim 135, wherein said pre-feeder unit has a rectangular plate known as feed plate (19) positioned in an inclined manner, in the bulk material flow direction, fixed to the brackets (169) welded to the inner sides of vertical, upper left side wall (85) and vertical, upper right side wall (82), with plurality of nuts and bolts (21).

137. The Impact hopper as claimed in claim 135, wherein said pre-feeder unit has two guide rails (20) fixed by welding and positioned wider in the receiving end and narrower in the delivery end.

138. The Impact hopper as claimed in claim 135, wherein said distributor unit comprises a thick base plate known as distributor base-plate (141) welded to the inner side of said front wall (80) and also welded to the inner side of said vertical, upper left side wall (85) and said vertical, upper right side wall (82), in an inclined position, for the free flow of bulk material, just below said pre-feeder, proceeding from said front wall (80) towards said back-wall (81) and ends just before touching said back wall (81) giving a gap known as the hit gap (87) which depends on the bulk material size range and speed at which the material slides down said distributor base-plate (141) and is fixed.

139. The Impact hopper as claimed in claim 135, wherein said distributor unit comprises a convex strip known as pre-expander (40) at the bulk material receiving end, set on top of said distributor base-plate (141).

140. The Impact hopper as claimed in claim 135, wherein two deflectors (88) are fixed at the two corners of the discharge end of said distributor base-plate (141).

141. The Impact hopper as claimed in claim 135, wherein said feed plate (19) ends just before said pre-expander (40) and focuses on the centre of said pre-expander (40) giving a gap known as feed-gap (222) which depends on the bulk material size range and speed at which the material slides down said feed-plate (19) and is fixed.

142. The Impact hopper as claimed in claim 135, wherein said hit bar (24) is located at said back wall (81) just above said inclined, removable, lower left side wall (36) and said inclined, removable, lower right side wall (31).

143. The Impact hopper as claimed in claim 135, wherein said streamliner (42) is a concave trapezium plate with a barrier blade (47) at its centre, fixed below the hit gap, in an inclined position, touching said inclined, removable, lower left side wall (36) and said inclined, removable, lower right side wall (31), bolted to said back-wall (81).

144. The Impact hopper as claimed in claim 135, wherein two slots (158) are provided in each of said removable bracket (159), in which two movable studs (48) move, which are connected to threaded holes (165) in said left arm (161) and said right arm (162) in said mini-expander unit, with lock nuts (203) at their ends.

145. The Impact hopper as claimed in claim 135, comprises a distributor unit which receives and spreads said bulk material to a thin layer using said pre-expander (40) delivering it to said hit bar (24), and said deflectors (88) prevent straying bulk material from hitting back wall corners.

146. The Impact hopper as claimed in claim 135, the hit-bar (24) gets hit by bulk material from said distributor unit that the smallest particles of bulk material fall close to said back-wall (81) and the bigger particles fall away from said back-wall (81), part of the bulk material falling on said lower-left-side wall (36) and said lower-right-side wall (31).

147. The Impact hopper as claimed in claim 135, comprises a streamliner (42) which is concave, receives falling material in a way major portion of said material flows to the centre towards said barrier plate (47) and delivers into said equaliser unit.

148. The Impact hopper as claimed in claim 135, wherein the impact hopper (1) comprises a mini-expander (43) which is a convex metal strip, receives the bulk material from said streamliner (42) and neutralises the convex portion of bulk material at the centre, making it flat.
